(19) United States
(12) Patent Application Publication
(10) Pub. No.: US 2026/0303596 A1
(43) Pub. Date: Oct. 1, 2026

(54) SELF-CORRECTING DATABASE BASED ON DEVICE-REPORTED INTEGRITY DATA

(71) Applicant: CenturyLink Intellectual Property LLC, Denver, CO (US)

(72) Inventor: Tim Hong, Parker, CO (US)

(73) Assignee: CenturyLink Intellectual Property LLC, Denver, CO (US)

(21) Appl. No.: 19/629,750

(22) Filed: Mar. 26, 2026

Related U.S. Application Data
(60) Provisional application No. 63/780,991, filed on Mar. 31, 2025.

(51) Int. Cl. H04L 9/40

(52) U.S. Cl. CPC H04L 63/0876; H04L 63/0846

(57) ABSTRACT

A system and method for providing a self-correcting device management database based on device-reported integrity data. A data record auditor of a device management system may receive an audit input indicating an account and/or an on-premises device registered to the account and perform various validation steps to verify and correct various data record fields of data records associated with the account to ensure their alignment. The auditor may verify a device ID of the on-premises device, verify a distribution transport network (DTN) assigned to the account, and then log into the on-premises device via the verified DTN to collect device-reported data. The auditor may check a wireless backhaul of the on-premises device, update the data record fields, and/or troubleshoot one or more on-premises device based on the device-reported data.

### CROSS-REFERENCE TO RELATED APPLICATIONS

This application claims the benefit of U.S. Provisional Application No. 63/780,991 filed Mar. 31, 2025, entitled “Self-Correcting Database Based On Device Reported Integrity Data,” which is incorporated herein by reference in its entirety.

### BACKGROUND

Wi-Fi is commonly used in a premises (e.g., a home or a business) to provide network access to wide area networks such as the Internet. Typically, a user signs up (e.g., creates an account) with a provisioning service that configures a network interface device (e.g., a modem) at the user's location to provide such network access. The network interface device may be part of a local area network that further includes one or more network extender devices (e.g., Wi-Fi pods) to extend wireless coverage within the user's premises.

The provisioning service may provide a remote management service that allows the user to manage their local area network via a user application. For instance, the user application may provide for managing and monitoring device connections, creating device groups, managing network settings, and/or other remote management functionalities. Additionally, the provisioning service may provide a technician portal that allows technicians to provision, deprovision, service, and/or otherwise manage a network interface device and/or network extender devices installed at a premises.

It is with respect to this general technical environment that aspects of the present disclosure are directed.

### SUMMARY

Aspects of the present disclosure describe a system and method for providing a self-correcting device management database based on device-reported integrity data. A data record auditor may perform various validation steps to verify and correct various fields of data record linked to a user account to ensure their alignment. The various validation steps may include verifying a distribution transport network assigned to the user account based on data provided by an asynchronous device manager database, an on-premises device manufacturer database, and an authentication server database, and then verifying the data records based on device-reported data provided by the on-premises devices connected to the verified distribution transport network.

According to an aspect, a method is described, comprising: retrieving a first data record associated with a user account from a first database, wherein the first data record includes a first device list including a first set of registered on-premises devices registered to the user account in a first platform; retrieving a second data record associated with the user account from a second database, wherein the second data record includes a second device list including a second set of registered on-premises devices registered to the user account in a second platform; verifying a distribution transport network (DTN) assigned to the user account in the first data record; logging into a first connected on-premises device connected to the verified DTN; retrieving first device-reported data from the first connected on-premises device; updating the first data record based on the first device-reported data; and updating the second data record based on the first data record.

According to another aspect, a system is described, comprising: at least one processing unit; and memory storing instructions that, when executed by the at least one processing unit, cause the system to perform operations comprising: retrieving a first data record associated with a user account from a first database, wherein the first data record includes a first device list including a first set of registered on-premises devices registered to the user account in a first platform; retrieving a second data record associated with the user account from a second database, wherein the second data record includes a second device list including a second set of registered on-premises devices registered to the user account in a second platform; verifying a distribution transport network (DTN) assigned to the user account in the first data record; logging into a first connected on-premises device connected to the verified DTN; retrieving first device-reported data from the first connected on-premises device; updating the first data record based on the first device-reported data; and updating the second data record based on the first data record.

According to another aspect, a method is described, comprising: retrieving a first data record associated with a user account from a first database, wherein the first data record includes a first device list including a first set of registered on-premises devices registered to the user account in a first platform; retrieving a second data record associated with the user account from a second database, wherein the second data record includes a second device list including a second set of registered on-premises devices registered to the user account in a second platform; obtaining a device identifier of a first registered on-premises device in the first set of registered on-premises devices from the first data record; retrieving a MAC address of the first registered on-premises device from a third database based on the device identifier of the first registered on-premises device; retrieving, from a fourth database, a recorded distribution transport network (DTN) identifier recorded in association with a network connection made by the first registered on-premises device via a connected DTN; and verifying a DTN assigned to the user account is the connected DTN connected to the first registered on-premises device when the recorded DTN identifier matches a DTN identifier of the DTN assigned to the user account in the first data record; or updating the DTN identifier assigned to the user account in the first data record when the recorded DTN identifier and the DTN identifier in the first data record do not match; logging into a first connected on-premises device connected to the verified DTN; retrieving first device-reported data from the first connected on-premises device; updating the first data record based on the first device-reported data, comprising: comparing a device identifier of the first connected on-premises device in the first device-reported data to a device identifier of the first registered on-premises device in the first set of registered on-premises devices; and verifying the first connected on-premises device is the first registered on-premises device when the device identifier of the first connected on-premises device matches the device identifier of the first registered on-premises device in the first set of registered on-premises devices; or updating the device identifier of the first registered on-premises device in the first data record when the device identifier of the first connected on-premises device and the device identifier of the first registered on-premises device in the first set of registered on-premises devices do not match; comparing a device identifier of the first registered on-premises device in the first set of registered on-premises devices to a device identifier of a second connected on-premises device connected to the first on-premises device in a wireless backhaul included in the first device-reported data; and verifying the second connected on-premises device is a second registered on-premises device in the first set of registered on-premises devices when the device identifier of the second connected on-premises device matches the device identifier of the second registered on-premises device; or updating the device identifier of the second registered on-premises device in the first data record when the device identifier of the second connected on-premises device and the device identifier of the second registered on-premises device in the first set of registered on-premises devices do not match; and updating the second data record based on the first data record.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram depicting an example device management system according to aspects of the present disclosure.

FIG. 2 is a block diagram depicting data aligned by a real-time orchestrator of the device management system according to aspects of the present disclosure.

FIGS. 3A-3C are block diagrams depicting various example data sources used to validate data records according to aspects of the present disclosure.

FIGS. 4A-4E depict an example method for providing a self-correcting device management database based on device-reported integrity data according to aspects of the present disclosure.

FIG. 5 is a block diagram of an example computing system that can be employed to perform aspects of the present disclosure.

### DETAILED DESCRIPTION

Wi-Fi is commonly used in premises, such as homes and businesses, for accessing wide area networks such as the Internet. Typically, a user at a particular premises signs up with a provisioning service to obtain network access and is given an account having an account identifier by the provisioning service. Based on information associated with the account, the provisioning service may provide, at the premises, a network interface device (e.g., a modem) with configuration information that allows the user to access the network. The network interface device may operate as a wired and/or wireless (Wi-Fi) router and may establish a local area network that further includes one or more Wi-Fi extender devices (e.g., pods) to extend Wi-Fi coverage within the user's premises.

According to an aspect, the provisioning service may include a real-time orchestrator that communicates across multiple platforms to perform device management actions on on-premises devices registered to a user account. In examples, data records corresponding to the user account and the on-premises devices may need to align across the multiple platforms for the device management actions to be performed as intended/expected. Thus, aspects of the present disclosure include a data record auditor that validates and self-corrects data records across multiple platform databases. For instance, the data record auditor may verify a service line to the service location and then use the verified service line to log into a connected on-premises device. Device-reported data may be retrieved from the on-premises device and the data records may be updated based on the device-reported data.

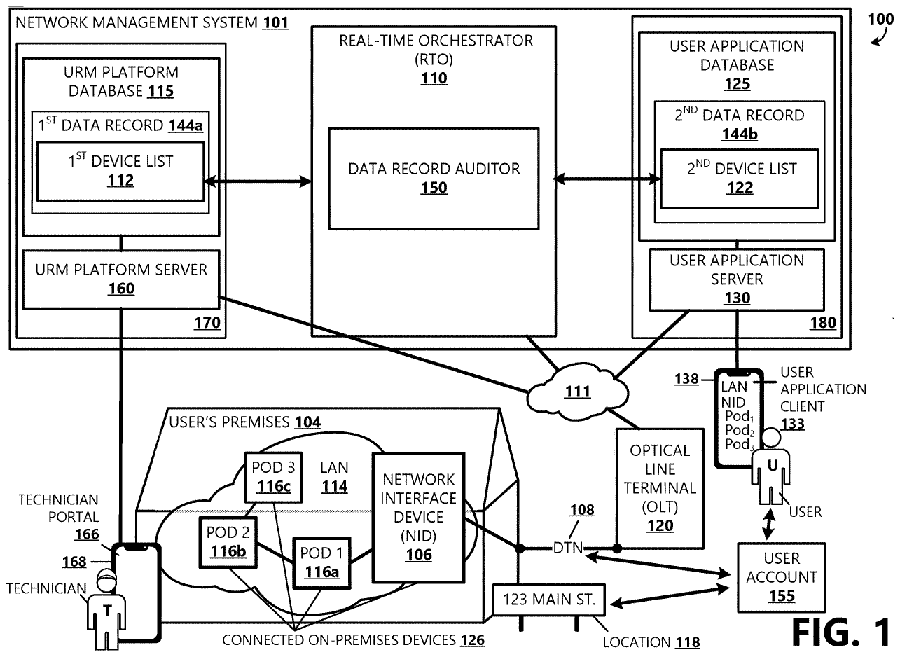

FIG. 1 illustrates an example system 100 in which a data record auditor 150 may be implemented for providing a self-correcting database of a network management system 101 based on device-reported integrity data. For instance, the device-reported integrity data may be obtained from on-premises devices 126 connected to a provisioning service's network 111 via a verified distribution transport network (DTN) 108. In examples, the provisioning service provides wide area network (WAN) access to users. The provisioning service may use the network management system 101 to manage (e.g., monitor, configure, provision, troubleshoot, etc.) on-premises devices 126 and connections registered in the provisioning service's network 111. The network management system 101 may include a real-time orchestrator (RTO) 110. The RTO 110 may include one or more computing devices and/or servers that connect with multiple platforms (e.g., cloud services, devices, and databases) to perform various real-time provisioning, network diagnostics, and/or immediate actions on on-premises devices 126.

A user of the provisioning service may be given/assigned a user account 155 (e.g., referenced by an account identifier (ID)) that enables the user to receive network access via on-premises devices 126 connected to the provisioning service's network 111 via a DTN 108 assigned and registered to the user account 155. Network access to the provisioning service's network 111 is provided by the DTN 108 assigned to the user account 155. The DTN 108 may originate from an optical line terminal (OLT) 120 (e.g., at a central network hub) and terminate at a service location 118 at which the user's premises 104 is positioned. For instance, a single DTN 108 is associated with a single premises 104 in the provisioning service's network 111. The premises 104 may be, for example, a single-family unit, a multi-dwelling unit (MDU), a multi-unit community, a business, or other site at which network access is desired.

One or more of the on-premises devices 126 connected to the provisioning service network 111 at the premises 104 may be provided by or otherwise be associated with the provisioning service and managed by the network management system 101. Example on-premises devices 126 include a network interface device (NID) 106 (e.g., a modem) and one or more network extension devices (referred to herein as pods 116a-116c (collectively, pods 116). For example, the NID 106 may serve as an interface between wiring/cables of the DTN 108 and internal wiring on-premises 104. In some implementations, the wiring/cables of the DTN 108 may include fiber-optic cable (sometimes referred to as fiber or fiber cable), copper cable, and/or other physical links/circuits that enable customers (e.g., the user) to access the provisioning service network 111 and wide area networks, such as the Internet, via the NID 106. Fiber cable can carry download and upload data at symmetrical high speeds over long distances using pulses of light. With Fiber to the Premises (FTTP) network connectivity, such as shown in the example illustrated in FIG. 1, feeder and distribution cable may be run from the OLT 120 to a transition box installed at the premises 104 (e.g., on an exterior of a building or unit).

In some examples, the NID 106 includes router capabilities for providing a wired and/or wireless local area network (LAN) 114 at the premises 104 to which one or more pods 116 and other wired or Wi-Fi-enabled devices (e.g., computing devices, smart televisions, gaming devices, smart home devices, printers, Internet of Things (IoT) devices, Voice over Internet Protocol (VoIP) phones, etc.) may connect. In examples, a pod 116 extends wireless coverage at the premises 104. For instance, a first pod 116a may be configured to connect to the NID 106, a second pod 116b may be configured to connect to the first pod 116a, and a third pod 116c may be configured to connect to the first pod 116 or the second pod 116b to create a daisy-chain configuration to extend the wireless LAN 114 coverage throughout the premises 104. A connection that links on-premises devices 126 to the provisioning service network 111 may be referred to as a “backhaul.” An example NID 106 that can be incorporated in the system 100 is described in U.S. patent application Ser. No. 17/569,666 titled “SMART NETWORK INTERFACE DEVICE” filed Jan. 6, 2022, the disclosure of which is incorporated by reference herein in its entirety.

In examples, the RTO 110 may function as a centralized system of various network management platforms with which it operates. For instance, the RTO 110 may interoperate with a user relations management (URM) platform 170 and a user application platform 180. The URM platform 170 and the user application platform 180 may each include a separate database to manage on-premises devices 126 that are registered to a user account 155 via the corresponding platform. For instance, the URM platform 170 may include a URM platform database 115 in which a first data record 144a corresponding to a particular user account 155 is stored. The first data record 144a may include a first device list 112 of on-premises devices 126 registered to the user account 155 via the URM platform 170. When an on-premises device 126 is registered to the user account 155 in the URM platform 170 (e.g., at installation) and connected to the provisioning service network 111, the network management system 101 may be able to track the on-premises device 126 (e.g., for provisioning the device for service, support, troubleshooting, billing, etc.).

Additionally, the user application platform 180 may include a user application database 125 in which a second data record 144b corresponding to the same user account 155 is stored. The second data record 144b may include a second device list 122 of on-premises devices 126 registered to the user account via the user application platform 180. When an on-premises device 126 is registered to the user account 155 in the user application platform 170, the user may be able to view and manage the on-premises device 126 via a user application client 133 operating on a user device 138 (e.g., a phone, tablet, laptop, desktop computer, wearable device, etc.). For instance, the user may choose to register the on-premises device 126 to their user account 155 in the user application platform 180 for application-based on-premises device 126 and LAN 114 management functions.

In some examples, the on-premises device 126 may be installed by a service technician of the provisioning service. For instance, the on-premises device 126 may be registered to the user account 155 by the service technician using a technician portal 166 in communication with a URM platform server 160 included in the URM platform 170. The technician portal 166 may operate on a technician device 168 (e.g., a phone, tablet, laptop, wearable device, or other mobile computing device). The technician portal 166 may communicate with the URM platform server 160 to enable the provisioning service technician to register, onboard, provision, deprovision, troubleshoot, and/or otherwise manage on-premises devices 126 (e.g., NIDs 106 and pods 116) at the premises 104 that are connected to the provisioning service's network 111. In some implementations, registering the on-premises device 126 to the user account 155 via the technician portal 166 may include connecting the on-premises device 126 (directly or indirectly) to the DTN 108, inputting a device identifier (ID), such as a serial number or other unique identifier assigned at the time of manufacture to the on-premises device 126, and sending the device ID to the URM platform server 160 to register to the user account 155 and store in the first device list 112. In some examples, a code may be included on an on-premises device 126, which may include or be linked to the device ID. The code may be input into the technician portal 166 (e.g., via a camera, near-field communication, or manual entry), which may send the code or linked device ID to the URM platform server 160 to register the on-premises device 126 to the user account 155 in the URM platform 170.

In some implementations, the on-premises device 126 may be installed by the user (or another non-technician user). In such examples, the on-premises device 126 may be automatically detected and registered to the user account 155 by an authentication platform of the network management system 101. For instance, when the on-premises device 126 connects to the provisioning service's network 111, MAC address tracking may be used by the authentication platform to recognize the on-premises device 126 as a new device and automatically associate the on-premises device 126 with the user account 155 by adding the on-premises device 126 to the first device list 112.

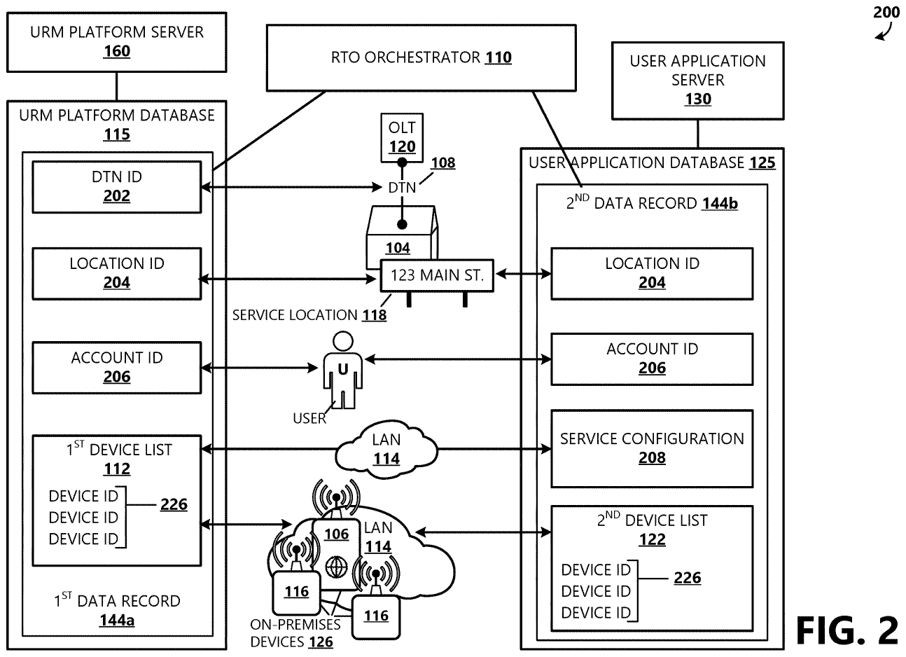

In some examples and as depicted in FIG. 2, the URM platform server 160 may register the on-premises device 126 to the user account 155 by storing, in the URM platform database 115, the device ID 226 of the on-premises device 126 in the first device list 112 of the first data record 144a associated with the user account 155. In some examples, the first data record 144a may be linked to the user account 155 via the account ID 206 of the user account 155 assigned to the user by the provisioning service. The first data record 144a may be further linked to the user account 155 via an identifier (DTN ID 202) of the DTN 108 connected at the service location 118 and/or an identifier (location ID 204) of the service location 118 of the DTN endpoint (e.g., an address of the premises 104).

In some examples and with reference again to FIG. 1, the user application client 133 may operate on a user device 138 (e.g., a phone, tablet, laptop, desktop computer, wearable device, etc.) and communicate with a user application server 130 of the user application platform 180 for allowing the user to manage their user account, manage and monitor device connections, create device groups, manage LAN settings (e.g., SSIDs, passwords, firewall settings, and/or parental controls), troubleshoot, and/or perform other remote device management functionalities.

In some implementations, registering the on-premises device 126 to the user account 155 via the user application client 133 may include connecting the on-premises device 126 (directly or indirectly) to the DTN 108, inputting the device ID 202 (e.g., via capturing the code or the device ID by a camera, near-field communication, or manual entry), and sending the device ID 202 to the user application server 130 to register and link the on-premises device 126 to the user account 155 in the user application platform 180.

In some examples and with reference again to FIG. 2, the user application server 130 may link the device ID 226 to the user account 155 by storing, in the user application database 125, the device ID 226 of the on-premises device 126 in the second device list 122 of the second data record 144b. In some examples, the second data record 144b may be linked to the user account 155 via the account ID 206 of the user account 155 assigned to the user by the provisioning service. The second data record 144b may be further linked to the user account 155 via the location ID 204 of the service location 118. In some examples, the second data record 144b may further include a service configuration 208 of the LAN 114. For instance, the service configuration 208 may include a service set identifier (SSID) assigned to the LAN 114 at the premises 104, a password associated with the SSID, firewall settings, etc. The service configuration 208 may be input and/or modified by the user via the user application client 133, which may be communicated to the user application server 130 to store in the second data record 144b in the user application database 125.

According to examples, device management functionalities enabled by the user application platform 180 may rely on an alignment of user account data from the URM platform 170 and the user application platform 180 to operate as intended. For instance, an incorrect or missing field in the first data record 144a and/or the second data record 144b, such as an incorrect or missing account ID 206, location ID 204, DTN ID 202, service configuration 208, device ID 226 (e.g., in the first device list 112 and/or the second device list 122), or other database corruption issues may cause the RTO 110 to be unable to align the first data record 144a and the second data record 144b. The incorrect/missing field or other database corruption issue may be associated with a variety of issues, such as an issue with the user application client 133, server 130, and/or database 125, migrating from a previous user application platform to the current user application platform 180, an on-premises device 126 not being onboarded correctly and/or needing a firmware upgrade, etc. Thus, to ensure alignment of the first data record 144a and the second data record 144b and operability of the user application platform 108 as intended/expected, the system 100 includes a data record auditor 150 that validates the data records 144 by connecting with multiple platforms (e.g., cloud services, on-premises devices 126, and databases) to obtain device-reported data that can be used to verify and, when needed, to troubleshoot on-premises devices 126 and/or correct the data records 144.

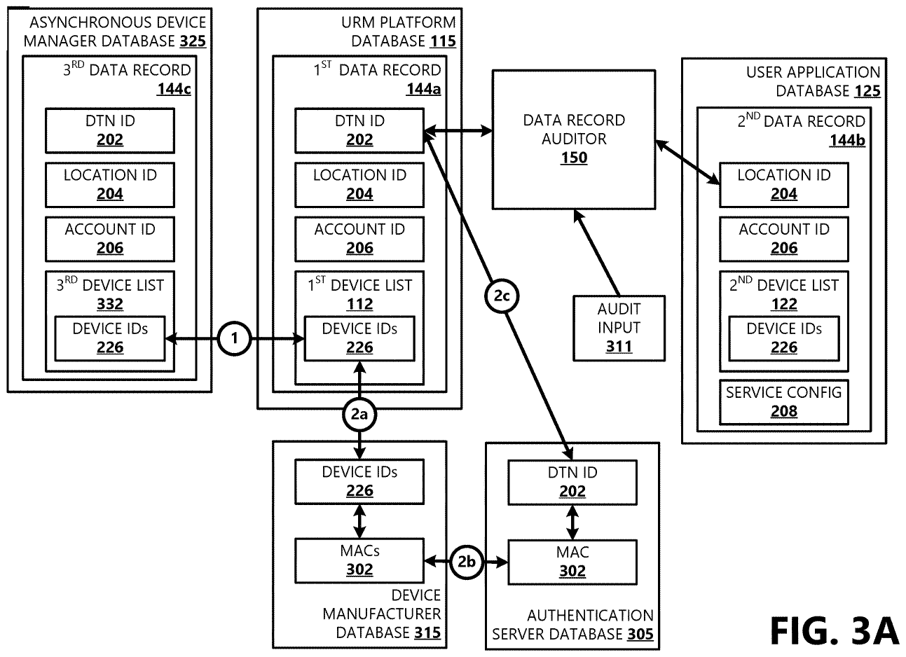

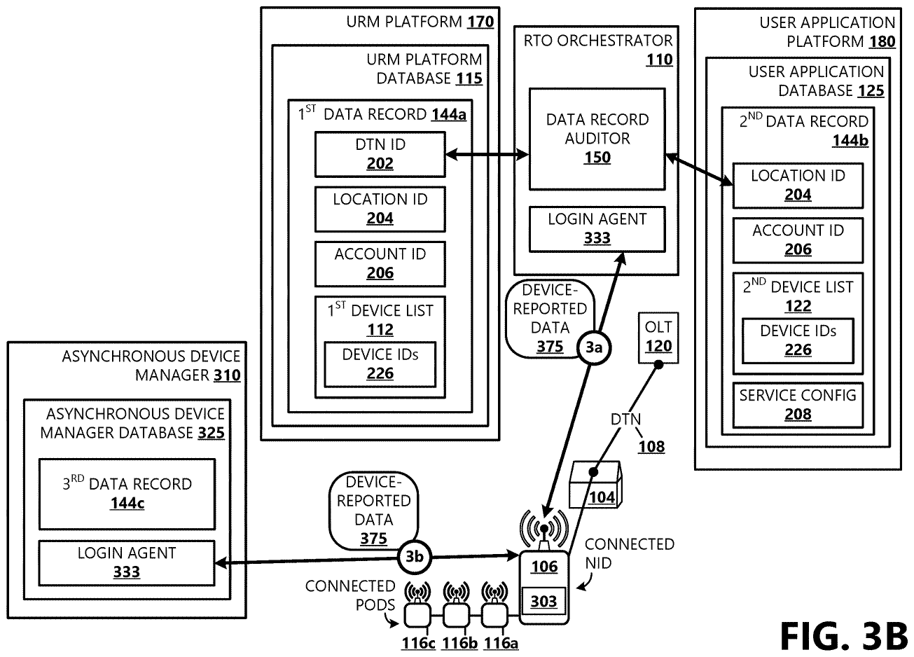

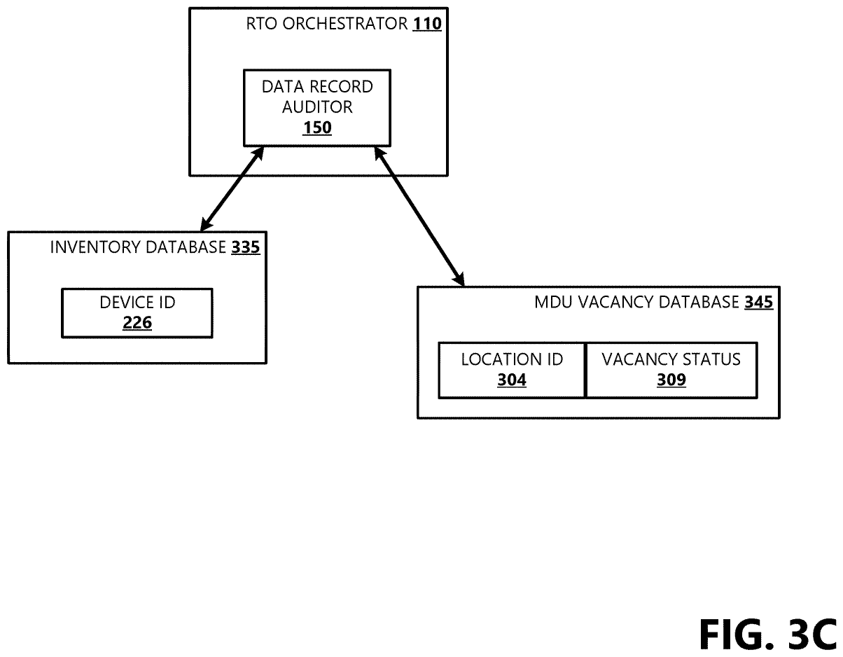

FIGS. 3A-3C depict various example data sources that the RTO 110 may be in communication with and that may be used by the data record auditor 150 to validate data records 144 (e.g., the first data record 144a and the second data record 144b) linked to the user account 155 according to aspects of the present disclosure. For instance, the data record auditor 150 may perform various validation steps to verify and correct various data record fields to ensure their alignment. The various validation steps may include verifying a DTN 108 assigned to the user account 155 based on data provided by an asynchronous device manager database 325, an on-premises device manufacturer database 315, and an authentication server database 305, and then verifying the data records 144 based on device-reported data 375 retrieved from the on-premises devices 126 connected to the verified DTN 108 at the service location 118.

With reference now to FIG. 3A, the data record auditor 150 may be configured to receive an audit input 311 indicating a user account 155 and/or an on-premises device 126 registered to the user account 155. For instance, the audit input 311 may include an identifier of a user account 155 (e.g., an account ID 206), a identifier of a service location 118 linked to the user account 155 (e.g., a DTN ID 202 or location ID 204), or an identifier of the on-premises device 126 registered to the user account 155 (e.g., a device ID 226). In some examples, the audit input 311 may be received based on a request to troubleshoot the on-premises device 126. In other examples, the audit input 311 may be received based on a request to audit the data records 144 associated with the on-premises device 126 and/or all on-premises devices 126 registered to the user account 155. In some implementations, in response to receiving an audit input 311, the data record auditor 150 may validate data records 144 associated with the audit input 311 (e.g., perform a data record audit). In some examples, the data record audit may include auditing a single set of data records 144 (e.g., including the first data record 144a and the second data record 144b). In other examples, the data record audit may include auditing a batch set of data records 144 (e.g., including a plurality of first 144a and second data records 144b associated with a plurality of user accounts 155). In some examples, the data record audit may include auditing data records 144 of a user account 155 based on installing an on-premises device 126 at a service location 118 of the user account 155. Other example data record auditing scenarios are contemplated.

In examples, the data record auditor 150 may query the URM platform database 115 for the first data record 144a based on the received audit input 311. For instance, when the audit input 311 indicates a user account 155 (e.g., includes a DTN ID 202, location ID 204, or an account ID 206), the data record auditor 150 may query the URM platform database 115 for and receive the first data record 144a (including the first device list 112 of device IDs 226 of on-premises devices 126 registered to the user account 155) based on the DTN ID 202, location ID 204, or account ID 206 received in the audit input 311. When the audit input 311 indicates an on-premises device 126 (e.g., includes a device ID 226 of a NID 106 or a pod 116), the data record auditor 150 may query the URM platform database 115 for and receive the first data record 144a linked to the user account 155 (including the first device list 112 that includes the on-premises device 126) based on the device ID 226 in the audit input 311.

The data record auditor 150 may further query the user application database 125 for and receive the second data record 144b based on the received audit input 311 and/or the first data record 144a. For instance, the second data record 144b may be linked to the user account 155 based on the location ID 204 and/or account ID 206. The second data record 144b may include the second device list 122 of on-premises devices 126 registered to the user account 155 by the user via the user application client 133. In some examples, the second data record 144b may further include the service configuration 208 of the user's LAN 114 (e.g., configured in the user application client 133 by the user).

A first validation step performed by the data record auditor 150 (indicated by a circled number 1) may include verifying the registered NID 106 based on data received from an asynchronous device manager database 325. In some examples, the RTO 110 may be implemented as a synchronous device manager and the asynchronous device manager database 325 may be implemented by an asynchronous device manager 310. The asynchronous device manager database 325 may store a third data record 144c associated with the user account 155. In examples, the third data record 144c includes a third device list 332 where NID-device IDs 226 of NIDS 106 connected to the provisioning service's network 111 via the DTN 108 assigned to the user account 155 are recorded. In some implementations, the data record auditor 150 may query the asynchronous device manager database 325 for and receive the third data record 144c based on the received audit input 311 and/or the first 144a and/or second data record 144b.

The data record auditor 150 may then compare the NID-device ID 226 received in the third data record 144c from the asynchronous device manager database 325 to the registered NID-device ID 226 included in the first data record 144a and/or second data record 144b. When the NID-device IDs 226 match, the data record auditor 150 may proceed to the next validation step. Alternatively, the data record auditor 150 may flag the audit input 311, the first data record 144a, the second data record 144b, and/or the third data record 144c for further analysis when the NID-device IDs 226 do not match.

In some implementations, a second validation step performed by the data record auditor 150 (represented by a circled numbers 2a, 2b, and 2c) may include verifying the DTN ID 202 of the registered NID 106 based on input received from an on-premises device manufacturer database 315. In examples, the on-premises device manufacturer database 315 may store device IDs 226 of each on-premises device 126 manufactured by a particular device manufacturer and the corresponding MAC addresses 302 assigned to the network interfaces (e.g., ethernet interfaces and wireless network interfaces) of each on-premises device 126. In some examples (and as indicated by circled number 2a), the data record auditor 150 may query the on-premises device manufacturer database 315 based on the NID-device ID 226 and obtain, in response to the query, the corresponding NID-MAC address 302. In further examples, the data record auditor 150 may query the on-premises device manufacturer database 315 for pod-MAC addresses 302 for each registered pod 116 included in the first device list 112 and/or the second device list 122.

In some implementations (and as indicated by circled number 2b), the second validation step further includes linking the NID-MAC address 302 obtained from the device manufacturer database 315 to a DTN ID 202 provided by a MAC address-based authentication server database 305. For instance, the provisioning service may use MAC address-based authentication for connections made by NIDs 106 to the provisioning service's network 111. When a NID 106 communicates with the provisioning service's network 111 (e.g., via a DTN 108), the MAC address 302 used by the NID 106 (to connect to the DTN 108) and the DTN ID 202 of the DTN 108 may be recorded by the authentication server database 305. The data record auditor 150 may query the authentication server database 305 using the MAC address(es) 302 obtained from the on-premises device manufacturer database 315 and obtain, in a response to the query, the corresponding DTN ID 202. The DTN ID 202 obtained from the authentication server database 305 may then be compared to the DTN ID 202 included in the first data record 144a (and as indicated by circled number 2c). When the DTN IDs 202 match, the DTN ID 202 from the first data record 144a and the corresponding DTN 108 of the claimed NID 104 may be verified as accurate. The data record auditor 150 may then proceed to a next validation step. Alternatively, the data record auditor 150 may flag the audit input 311, the first data record 144a, and/or the second data record 144b for further analysis when the DTN IDs 202 do not match.

In some implementations, the data record auditor 150 may be configured to correct a flagged data record 144. For instance, if the DTN ID 202 obtained from the authentication server database 305 does not match the DTN ID 202 included in the first data record 144a, the data record auditor 150 may back up the first data record 144a and then update the first data record 144a with the DTN ID 202 received from the authentication server database 305. The data record auditor 150 may further update the first data record 144a and/or the second data record 144b with a location ID 204 of the service location 118 that corresponds to the updated DTN ID 202.

With reference now to FIG. 3B, a third validation step performed by the data record auditor 150 (and as indicated by circled numbers 3a or 3b) may include obtaining data directly from the on-premises device(s) 126 connected to the provisioning service's network 111 via the verified DTN 108 and then verifying the first data record 144a and/or second data record 144b based on received data. For instance, the data record auditor 150 may use a login agent 333 included in the RTO 110 (as indicated by circled number 3a) or a login agent 333 included in the asynchronous device manager 310 (as indicated by circled number 3b) to remotely access and log into the NID 106 connected to the DTN 108 corresponding to the DTN ID 202 that was verified in the second validation step.

In examples, the data record auditor 150 may log into the device driver 303 of the connected NID 106 and obtain a first set of device-reported data 375 from the device driver 303. For instance, the first set of device-reported data 375 may include system-level details about the connected NID 106, such as the connected NID's device ID 226, firmware version, hardware (model) ID, MAC addresses 302, LAN IP address, public IP address, DHCP table of connected pods 116a-116c, etc.

In some examples, the data record auditor 150 may determine, based on the first set of device-reported data 375, whether the connected NID 106 is the registered NID 106 in the first data record 144a and/or second data record 144b. For instance, the connected NID's device ID 226 may be compared with the NID-device ID 226 of the registered NID 106 in the first data record 144a and/or second data record 144b. When the device IDs 226 match, the registered NID 106 may be verified in the corresponding data record 144. The data record auditor 150 may then proceed to a next validation step. In some examples, when the device IDs 226 do not match, the data record auditor 150 may update the first data record 144a and/or second data record 144b based on the first set of device-reported data 375. For instance, if the connected NID 106 is not included in the first data record 144a and/or second data record 144b, the connected NID 106 may be added and registered to the user account in the URM platform 170 and/or the user application platform 180.

In some examples, the data record auditor 150 may further determine, based on the first set of device-reported data 375, whether the firmware version of the connected NID 106 is the latest version. When the firmware version is not the latest version, the data record auditor 150 may update the firmware. In some examples, the data record auditor 150 may perform a factory reset of the connected NID 106, such as if the status of the connected NID 106 is indicated as being offline although connected to the provisioning service's network 111.

The data record auditor 150 may further resynchronize the first data record 144a and/or the second data record 144b. In some examples, the data record auditor 150 may trigger the URM platform database 115 and/or the user application database 125 to refresh after the factory reset of the connected NID 106. Accordingly, connection status information in the first data list 112 and/or second data list 122 may be updated. For instance, if the registered NID 106 was previously indicated as having an offline status prior to the firmware update and/or factory reset, the first data record 144a and/or the second data record 144b may be checked to determine whether the registered NID's offline status has been updated to an online status after the firmware update and/or factory reset.

In some examples, the data record auditor 150 may further check the wireless backhaul of connections to pods 116 in the device-reported data 375 to determine whether the DHCP table and/or updated DHCP table in the first and/or second set of device-reported data 375 matches the first device list 112 and/or the second device list 122. In some implementations, if the connected pods 116 in the DHCP table match the registered pods 116 in the first device list 112 and/or the second device list 122, the registered pods 116 may be verified in the corresponding data record 144. The data record auditor 150 may then proceed to a next validation step. In some examples, when the connected pods 116 and registered pods 116 do not match, the data record auditor 150 may update the first data record 144a and/or second data record 144b based on the device-reported data 375. For instance, if a connected pod 116 is not included in the first data record 144a and/or second data record 144b, the connected pod 116 may be added and registered to the user account 155 in the URM platform 170 and/or the user application platform 180. Additionally, if a registered pod 116 in the first device list 112 and/or the second device list 122 is not included in the DHCP table of connected pods 116 in the wireless backhaul, the registered pod 116 may be unregistered from the user account 155 in the URM platform 170 and/or the user application platform 180.

In some examples, the data record auditor 150 may further use the login agent 333 of the RTO 110 or the login agent 333 of the asynchronous device manager 310 to remotely access and log into a first connected pod 116a in the wireless backhaul. For instance, the data record auditor 150 may log into the device driver 303 of the first connected pod 116a and obtain a second set of device-reported data 375 from the pod's device driver 303. The second set of device-reported data 375 may include system-level details about the first connected pod 116a, such as the device ID 226, firmware version, hardware (model) ID, MAC addresses 302, LAN IP address, public IP address, pods 116 connected via a wireless backhaul, etc.

In some examples, the data record auditor 150 may determine, based on the second set of device-reported data 375, whether the firmware version of the first connected pod 116a is the latest version. When the firmware version is not the latest version, the data record auditor 150 may update the firmware of the first connected pod 116a. In further examples, the data record auditor 150 may run various commands to troubleshoot and re-establish a backhaul connection that may have a failure. For instance, the data record auditor 150 may run a command to force the first connected pod 116a to resynchronize with the connected NID 106, to restart the pod's Wi-Fi radio, adjust frequency settings, perform a factory reset, and/or reprovision the first connected pod 116a.

The data record auditor 150 may further resynchronize the first data record 144a and/or the second data record 144b. In some examples, the data record auditor 150 may trigger the URM platform database 115 and/or the user application database 125 to refresh after the factory reset of the connected pod 116. Accordingly, connection status information in the first data list 112 and/or second data list 122 may be updated. For instance, if the registered pod 116 was previously indicated as having an offline status prior to the firmware update and/or factory reset, the first data record 144a and/or the second data record 144b may be checked to determine whether the registered pod's offline status has been updated to an online status after the firmware update and/or factory reset. The data record auditor 150 may repeat the process of using the login agent 333 to log into each of the remaining connected pods 116 in the wireless backhaul to collect device-reported data 375 and then either verify or troubleshoot (e.g., update the firmware and/or run various commands to troubleshoot and re-establish a backhaul connection of) the connected pod(s) 116 if necessary.

After validating the final connected pod 116 in the wireless backhaul, the data record auditor 150 may further determine whether the service configuration 208 may be missing in the second data record 144b. For instance, when security service configuration information, such as the SSID and password of the NID 106, is missing, the data record auditor 150 may re-log into the connected NID 106 via the login agent 333 and retrieve the service configuration 208 from the device driver 303. The data record auditor 150 may further store the security service configuration 208 in the second data record 144b.

In some examples, the service configuration 208 may be missing from the device-reported data 375 when the premises 104 of the service location 118 is vacant. In some examples, and with reference now to FIG. 3C, the data record auditor 150 may query an MDU vacancy status database 345 to determine a vacancy status 309 of the service location 118 (e.g., identified by the location ID 304). If the premises 104 is vacant, the service configuration field in the second data record 144b may be left blank. In other cases, the premises 104 may be occupied and the service configuration 208 may be corrupted. Accordingly, the data record auditor 150 may generate a temporary SSID and password for the user account 155 and send a linked code to the user (e.g., via email, text, or the user application client 133).

In some examples, an inventory database 335 may record on-premises devices 126 that are identified as being in storage (e.g., and, thus, not registered to a user account 155). The data record auditor 150 may determine whether the inventory database 335 includes any device IDs 226 of the on-premises devices 126 registered to the user account 155 and connected to the provisioning service network 111 at the service location 118. If a device ID 226 is detected, the data record auditor 150 may update the provisioning status of the particular on-premises device 126 to an un-provisioned status in the first data record 144a. In examples, the un-provisioned status may prevent the on-premises device 126 from being able to connect to the provisioning service network 111 (e.g., until it is scanned by the technician portal 166 and registered to a user account 155 by the URM platform 170).

After performing the various validation steps, the first data record 144a and the second data record 144b may be updated and synchronized based on the device-reported data 375 received from the verified connected on-premises devices 126 linked to the user account 155. Accordingly, the device management functionalities enabled by the user application platform 180 may operate as intended/expected. For instance, when the user wants to view or manage their LAN 114 using the user application client 133, the on-premises devices 126 registered to the user account 155 may be displayed and configurable by the user application client 133 on the user device 138.

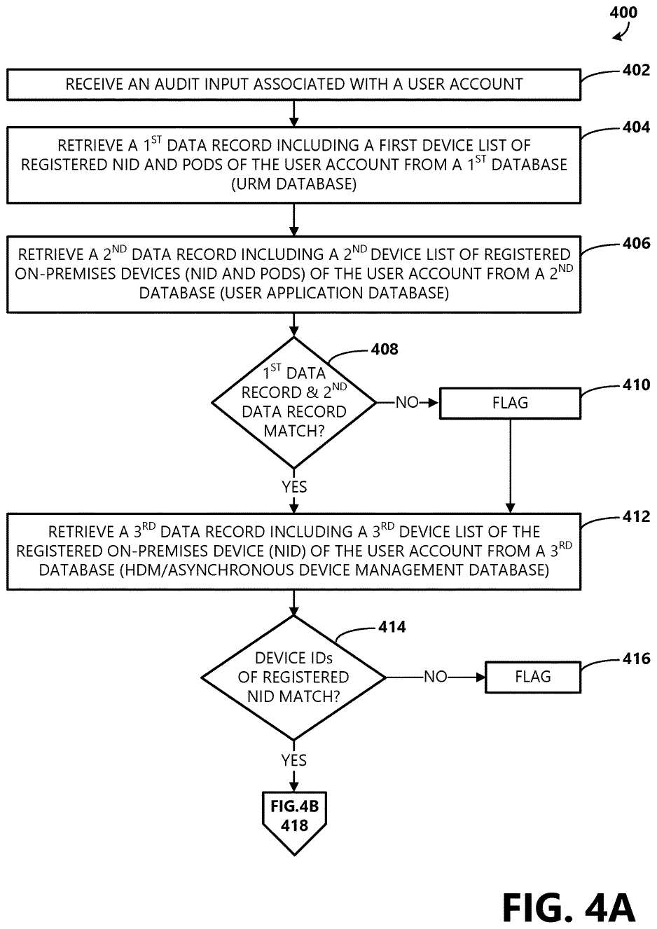

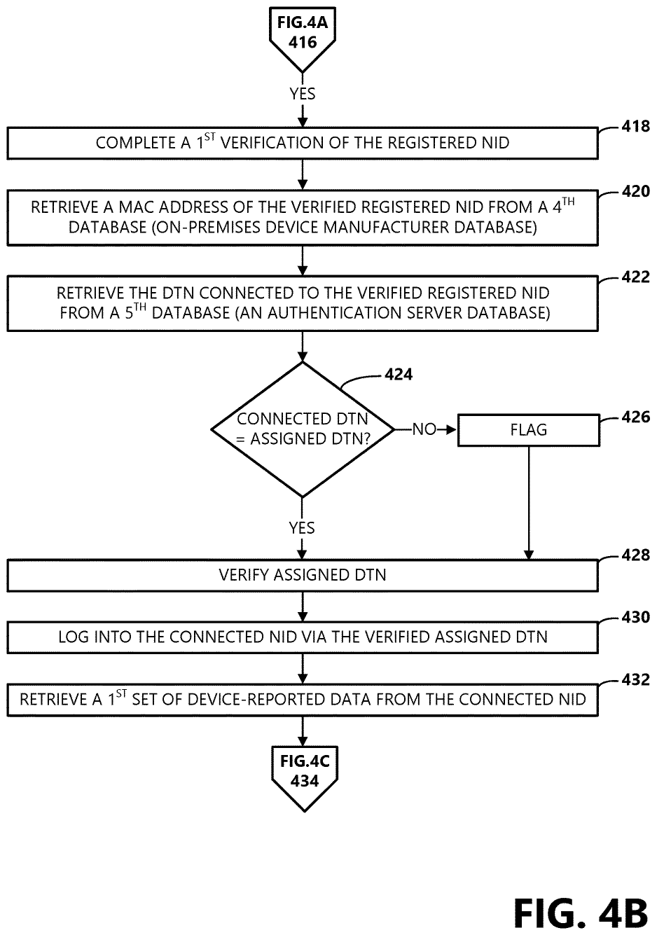

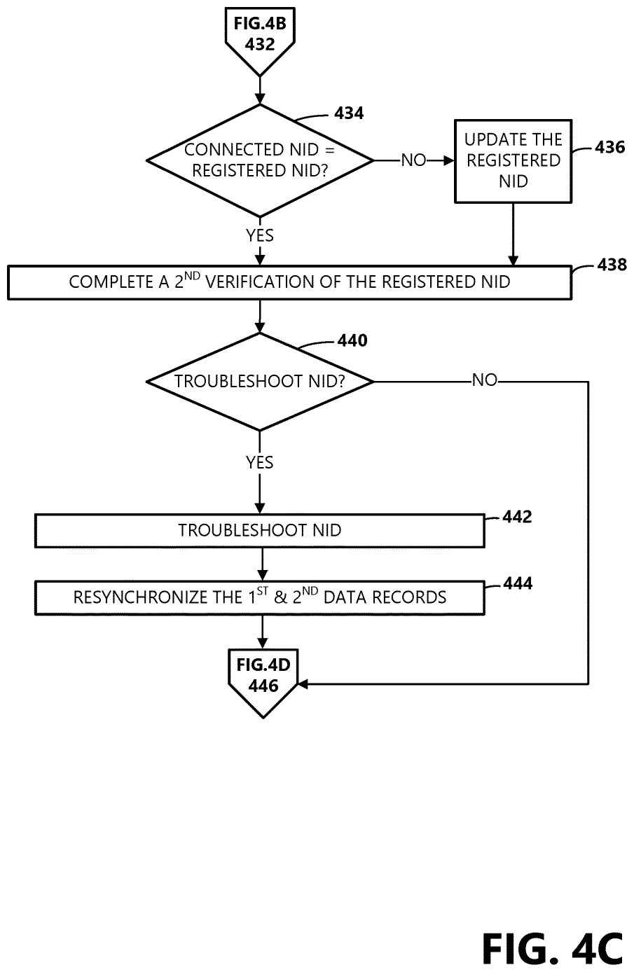

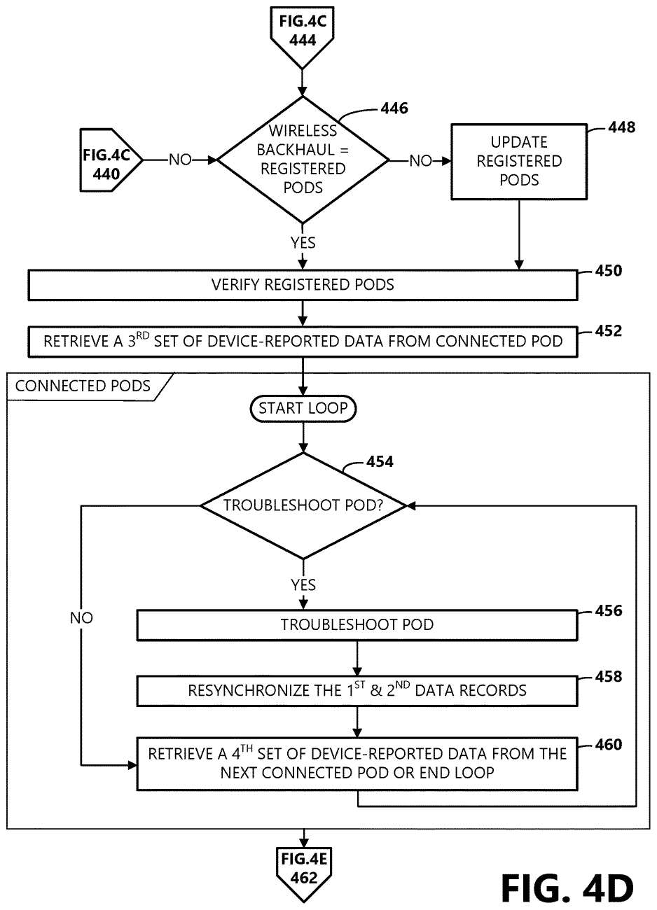

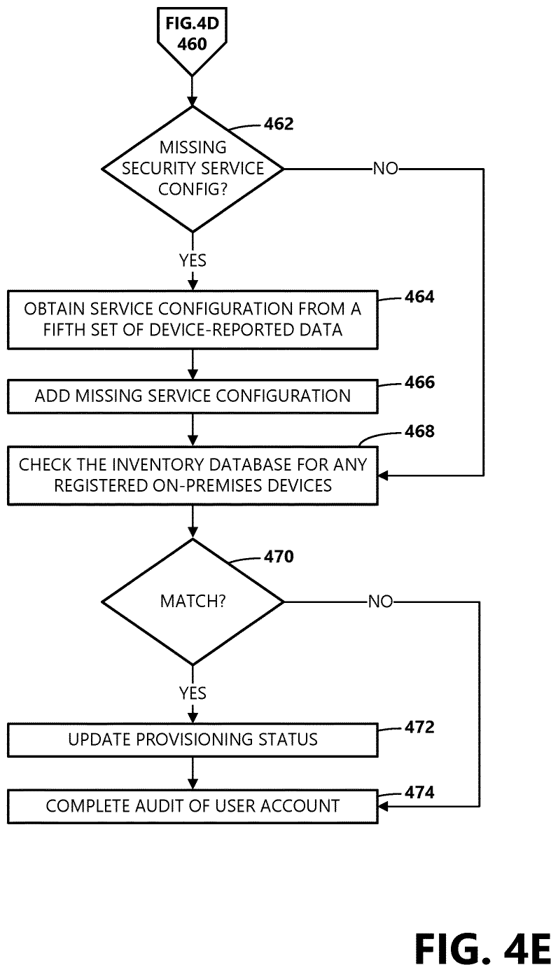

FIGS. 4A-4E depict an example method 400 for providing a self-correcting device management database based on device-reported integrity data. For instance, the operations of method 400 may be executed by the data record auditor 150 to perform a data record audit according to aspects of the present disclosure. With reference now to FIG. 4A, an audit input 311 associated with a user account 155 may be received at operation 402. For instance, the audit input 311 may indicate the user account 155 (e.g., include an account ID 206, location ID 204, and/or DTN ID 202) or may indicate an on-premises device 126 (e.g., a device ID 226 of a NID 106 or a pod 116) registered to the user account 155.

At operation 404, a first data record 144a including a first device list 112 of registered on-premises devices 126 (e.g., a NID 106 and pods 116) may be retrieved from a first database (e.g., the URM platform database 115). For instance, the first device list 112 may include on-premises devices 126 registered to the user account 155 in the URM platform 170 (e.g., by a technician using the technician portal 166 during installation of the on-premises devices 126 at the service location 118).

At operation 406, a second data record 144b including a second device list 122 of registered on-premises devices 126 may be retrieved from a second database (e.g., the user application platform database 125). For instance, the second device list 122 may include on-premises devices 126 registered to the user account 155 in the user application platform 180 (e.g., by a user using the user application client 133). In examples, for the user application platform 180 to operate as intended/expected, the first data record 144a and the second data record 144b may need to be in alignment

At decision operation 408, a determination may be made as to whether the first data record 144a and the second data record 144b match. For instance, if there is a misalignment between data record fields shared between the data records 144 (e.g., the location ID 204, account ID 206, and device IDs 226 (in the first device list 112 and the second device list 122)), the audit input 311, the first data record 144a, and/or the second data record 144b may be flagged at operation 410.

At operation 412, a third data record 144c including a third device list 332 may be retrieved from a third database (e.g., the asynchronous device manager database 325). For instance, the asynchronous device manager database 325 may store records of NIDs 106 registered to user accounts 155 and the third device list 332 may include the device ID 226 of the NID 106 registered to the user account 155.

At decision operation 414, the device ID 226 of the registered NID 106 in the first device list 112 and/or second device list 122 may be compared to the device ID 226 of the registered NID 106 in the third device list 332. If the device IDs 226 do not match, the audit input 311, the first data record 144a, the second data record 144b, and/or the third data record 144c may be flagged at operation 416. When the device IDs 226 match, the method 400 may proceed to operation 418 (in FIG. 4B), where the registered NID 106 in the first device list 112 and/or second device list 122 may complete a first verification.

At operation 420, the MAC address 302 of the registered NID 106 may be retrieved from a fourth database (e.g., the device manufacturer database 315). For instance, the data record auditor 150 may query the device manufacturer database 315 for the MAC address 302 corresponding to the device ID of the registered NID 106. In some examples, the data record auditor 150 may further retrieve the MAC addresses 302 of the registered pods 116 (e.g., in the first device list 112 and/or the second device list 122) from the device manufacturer database 315.

At operation 422, a fifth database (e.g., the MAC address-based authentication server database 305) may be queried for the DTN ID 202 of the DTN 108 associated with the MAC address 302 retrieved at operation 420. For instance, when the NID 106 with the corresponding MAC address 302 connects to the provisioning service's network 111 via a DTN 108, the corresponding DTN ID 202 and MAC address 302 of the NID 106 may be recorded in the authentication server database 305.

At decision operation 424, a determination may be made as to whether the connected DTN ID 202 obtained from the authentication server database 305 matches the DTN ID 202 assigned to the user account 155 (and included in the first data record 144a and the third data record 144c). If the DTN IDs 202 do not match, at operation 426, the audit input 311, the first data record 144a and/or the third data record 144c may be flagged.

When the DTN IDs 202 match, the method 400 may proceed to operation 428, where the assigned DTN ID 202 in the first data record 144a and the third data record 144c may be verified as the DTN 108 connected to the connected NID 106. In some examples, if the first data record 144a and/or the third data record 144c was flagged at operation 426, the assigned DTN ID 202 in the corresponding data record 144 may be updated with the verified connected DTN ID 202.

At operation 430, the verified assigned DTN ID 202 may be used to log into the NID 106 connected to the DTN 108 corresponding to the DTN ID 202. For instance, the data record auditor 150 may use the login agent 333 included in the RTO 110 or the asynchronous device manager 310 to log into the device driver 303 of the connected NID 106.

At operation 432, a first set of device-reported data 375 may be retrieved from the connected NID 106. For instance, the first set of device-reported data 375 may include system-level details about the connected NID 106, such as the connected NID's device ID 226, firmware version, hardware (model) ID, MAC addresses 302, LAN IP address, public IP address, DHCP table of connected pods 116, etc.

At decision operation 434 (in FIG. 4C), a determination may be made, based on the first set of device-reported data 375, whether the connected NID 106 matches the registered NID 106 in the first data list 112 and/or second data list 122. For instance, the data record auditor 150 may compare the connected NID's device ID 226 in the first set of device-reported data 375 to the registered NID-device ID 226 in the first data list 112 and/or second data list 122. When the device IDs 226 match, the registered NID 106 may complete a second verification at operation 438 and, thus, may be verified in the corresponding data record(s) 144.

In some examples, when the NID-device IDs 226 do not match at decision operation 434, the first data record 144a and/or second data record 144b may be updated based on the first set of device-reported data 375 at operation 436. For instance, if the connected NID 106 is not included in the first data list 112 and/or second data list 122, the data record auditor 150 may add the connected NID 106 to the first data list 112 and/or second data list 122, which may register the connected NID 106 to the user account 155 in the URM platform 170 and/or the user application platform 180.

At decision operation 440, a determination may be made as to whether to troubleshoot the connected NID 106. For instance, the data record auditor 150 may determine, based on the first set of device-reported data 375, whether the firmware version of the connected NID 106 is a latest version. When the firmware version is not the latest version, the firmware may be updated at operation 442. In other examples, the data record auditor 150 may determine whether to restart the pod's Wi-Fi radio, adjust frequency settings, perform a factory reset, and/or reprovision the connected NID 106, and/or other troubleshooting functions. For instance, if data record auditor 150 detects the connection status of the connected NID 106 is indicated as offline even though it is connected to the provisioning service's network 111 and communicating with the data record auditor 150, a determination may be made by the data record auditor 150 to perform a factory reset of the connected NID 106.

In some examples, based on the determination made at decision operation 440, the connected NID 106 may be troubleshooted at operation 442. For instance, when the firmware version is not the latest version, the firmware may be updated at operation 442 and/or the data record auditor 150 may run various commands to force the NID 106 to resynchronize with the RTO 110, to restart the NID's Wi-Fi radio, adjust frequency settings, perform a factory reset, and/or reprovision the NID 106.

At operation 444, the first data record 144a and/or the second data record 144b may be resynchronized. For instance, the URM platform database 115 and/or the user application database 125 may be triggered to refresh after the factory reset. After the refresh, the first data list 112 and/or second data list 122 may be updated.

With reference now to FIG. 4D, after operation 444 or after a no determination is made at decision operation 440, the method 400 may proceed to decision operation 446, where a determination may be made as to whether the wireless backhaul of connected pods 116 (e.g., in the DHCP table) matches the registered pods 116 in the first data list 112 and/or second data list 122. When the connected pods 116 in the DHCP table match the registered pods 116 in the first device list 112 and/or the second device list 122, the registered pods 116 may be verified in the corresponding data record 144 at operation 450.

In some examples, when the connected pods 116 and registered pods 116 do not match, the first data record 144a and/or second data record 144b may be updated at operation 448 based on the connected pods 116 reported in the device-reported data 375. For instance, if a connected pod 116 is not included in the first data list 112 and/or second data list 122, the connected pod 116 may be added and registered to the user account 155 in the URM platform 170 and/or the user application platform 180.

At operation 452, a third set of device-reported data 375 may be obtained from a first connected pod 116 in the wireless backhaul. For instance, the data record auditor 150 may use the login agent 333 of the RTO 110 or the login agent 333 of the asynchronous device manager 310 to log into the device driver 303 of the first connected pod 116 to obtain the third set of device-reported data 375. The third set of device-reported data 375 may include system-level details about the first connected pod 116a, such as the device ID 226, firmware version, hardware (model) ID, MAC addresses 302, LAN IP address, public IP address, pods 116 connected via a wireless backhaul, etc.

Operations 454-460 may be included in a loop and repeated for each connected pod 116 in the wireless backhaul. At decision operation 454, a determination may be made as to whether to troubleshoot the connected pod 116. For instance, the data record auditor 150 may determine, based on the third set of device-reported data 375, whether the firmware version of the connected pod 116 is a latest version, to restart the pod's Wi-Fi radio, adjust frequency settings, perform a factory reset, and/or reprovision the connected pod 116, and/or perform other troubleshooting functions.

In some examples, based on the determination at decision operation 454 the connected pod 116 may be troubleshooted at operation 456. For instance, the data record auditor 150 may run various commands to troubleshoot and re-establish a backhaul connection that may have a failure. For instance, the data record auditor 150 may update the firmware and/or run a command to force the connected pod 116 to resynchronize with its controller, to restart the pod's Wi-Fi radio, adjust frequency settings, perform a factory reset, and/or reprovision the connected pod 116.

At operation 458, the first data record 144a and/or the second data record 144b may be resynchronized. For instance, the URM platform database 115 and/or the user application database 125 may be refreshed after the connected pod 116 is troubleshooted and the first data list 112 and/or second data list 122 may be updated. For instance, the connection status of the connected pod 116 and/or other connected pods 116 in the wireless backhaul may be updated from being offline to online.

At operation 460, a fourth set of device-reported data 375 may be retrieved from the device driver 303 of the next connected pod 116 in the wireless backhaul. For instance, the data record auditor 150 may use the login agent 333 of the RTO 110 or the login agent 333 of the asynchronous device manager 310 to log into the device driver 303 of the next connected pod 116 to obtain the fourth set of device-reported data 375 of system-level details about the next connected pod 116. The loop may return to operation 454 or may end after retrieving device-reported data 375 from the last connected pod 116 in the wireless backhaul or after troubleshooting the last connected pod 116 in the wireless backhaul, if a failure is detected in the backhaul.

After operations 454-460 have been performed for each connected pod 116 in the wireless backhaul, the method 400 may proceed to decision operation 462 in FIG. 4E, where a determination may be made as to whether the service configuration 208 may be incorrect or missing in the second data record 144b.

In examples where the security service configuration 208 (e.g., SSIDs, passwords) may be incorrect or missing, a fifth set of device-reported data 375 may be retrieved from the device driver 303 of the connected NID 106 including the service configuration 208 of the LAN 114 at operation 464.

At operation 466, the retrieved service configuration 208 from the connected NID 106 may be added to the second data record 144b. In some examples, the service configuration 208 may be additionally missing from the fifth set of device-reported data 375. In such cases, a determination may be made as to whether the premises 104 of the service location 118 is vacant or not. For instance, the data record auditor 150 may retrieve a vacancy status 309 indicator from the MDU vacancy status database 345 and determine whether the premises 104 is identified as having a vacant or occupied vacancy status 309. If the premises 104 is vacant, the service configuration field in the second data record 144b may be left blank. In other cases, the premises 104 may be occupied and the service configuration 208 may be corrupted. Thus, a temporary SSID and password may be generated for the user account 155, linked to a code, and the code may be sent to the user (e.g., via email, text, or the user application client 133).

At operation 468, the inventory database 335 may be checked for any of the on-premises devices 126 registered to the user account 155. For instance, the inventory database 335 may record on-premises devices 126 that are identified as being in storage. If the device ID 226 of a particular on-premises device 126 that is registered to the user account 155 is matched to the device ID 226 in the inventory database 335 at decision operation 470, the data record auditor 150 may update the provisioning status of the particular on-premises device 126 to an un-provisioned status at operation 472. For instance, when an on-premises device 126 has an un-provisioned status, the on-premises device 126 may need to be registered to a user account 155 by the URM platform 170 (e.g., by a technician using the technician portal 166) in order for the particular on-premises device 126 to be able to connect to the provisioning service network 111.

At operation 474, the data record audit of the user account 155 may be completed. Accordingly, the first data record 144a and the second data record 144b may be updated and synchronized based on the device-reported data 375 received from the verified connected on-premises devices 126 linked to the user account 155. The device management functionalities provided by the user application platform 180 for the on-premises devices 126 registered to the user account 155 may then operate as intended/expected. For instance, when the user application client 133 is used to view or manage the user's LAN 114, the on-premises devices 126 registered to the user account 155 may be displayed and configurable by the user on the user device 138.

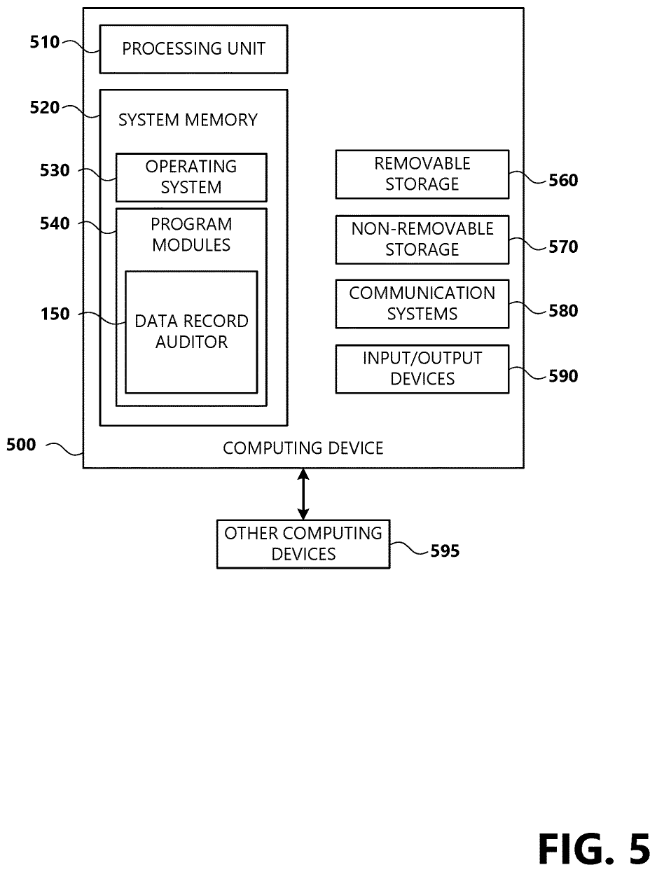

FIG. 5 is a system diagram of a computing device 500 according to an example. The computing device 500, or various components and systems of the computing device 500, may be integrated or associated with one or more components of system 100. As shown in FIG. 5, the physical components (e.g., hardware) of the computing device 500 are illustrated and these physical components may be used to practice the various aspects of the present disclosure.

The computing device 500 may include at least one processing unit 510 and a system memory 520. The system memory 520 may include, but is not limited to, volatile storage (e.g., random access memory), non-volatile storage (e.g., read-only memory), flash memory, or any combination of such memories. The system memory 520 may also include an operating system 530 that controls the operation of the computing device 500 and one or more program modules 540. The program modules 540 may be responsible for performing one more of the operations of the method 400 described above for providing a self-correcting device management database based on device-reported integrity data. A number of different program modules and data files may be stored in the system memory 520. While executing on the processing unit 510, the program modules 540 may perform the various processes described above. One example program module 540 includes the data record auditor 150.

The computing device 500 may also have additional features or functionality. For example, the computing device 500 may include additional data storage devices (e.g., removable and/or non-removable storage devices) such as, for example, magnetic disks, optical disks, or tape. These additional storage devices are labeled as a removable storage 560 and a non-removable storage 570.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 5 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 500 on the single integrated circuit (chip). The disclosure may also be practiced using other technologies capable of performing logical operations such as, for example, AND, OR, and NOT, including but not limited to mechanical, optical, fluidic, and quantum technologies.

The computing device 500 may include one or more communication systems 580 that enable the computing device 500 to communicate with other computing devices 595 such as, for example, routing engines, gateways, signings systems and the like. Examples of communication systems 580 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 500 may also have one or more input devices and/or one or more output devices shown as input/output devices 590. These input/output devices 590 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 520, the removable storage 560, and the non-removable storage 570 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method, comprising:
retrieving a first data record associated with a user account from a first database, wherein the first data record includes a first device list including a first set of registered on-premises devices registered to the user account in a first platform;
retrieving a second data record associated with the user account from a second database, wherein the second data record includes a second device list including a second set of registered on-premises devices registered to the user account in a second platform;
verifying a distribution transport network (DTN) assigned to the user account in the first data record;
logging into a first connected on-premises device connected to the verified DTN;
retrieving first device-reported data from the first connected on-premises device;
updating the first data record based on the first device-reported data; and
updating the second data record based on the first data record.

2. The method of claim 1, wherein verifying the DTN assigned to the user account in the first data record comprises:
obtaining a device identifier of a first registered on-premises device in the first set of registered on-premises devices from the first data record;
retrieving a MAC address of the first registered on-premises device from a third database based on the device identifier of the first registered on-premises device;
retrieving, from a fourth database, a recorded DTN identifier recorded in association with a network connection made by the first connected on-premises device via a connected DTN; and
verifying the DTN assigned to the user account is the connected DTN connected to the first registered on-premises device when the recorded DTN identifier matches a DTN identifier of the DTN assigned to the user account in the first data record; or
updating the DTN identifier assigned to the user account in the first data record when the recorded DTN identifier and the DTN identifier in the first data record do not match.

3. The method of claim 2, further comprising:
determining a service location corresponding to the verified DTN;
comparing a location identifier corresponding to the verified DTN to a location identifier included in the first data record;
verifying the location identifier included in the first data record when the location identifier included in the first data record matches the location identifier corresponding to the verified DTN; and
updating the location identifier included in the first data record to the location identifier corresponding to the verified DTN when the location identifier included in the first data record and the location identifier corresponding to the verified DTN do not match.

4. The method of claim 2, further comprising: prior to retrieving the MAC address of the first connected on-premises device, verifying the device identifier of the first connected on-premises device with a fifth database.

5. The method of claim 1, further comprising:
determining, based on the first device-reported data, the first connected on-premises device needs troubleshooting; and
troubleshooting the first connected on-premises device.

6. The method of claim 1, wherein updating the first data record based on the first device-reported data comprises:
comparing a device identifier of the first connected on-premises device in the first device-reported data to a device identifier of a first registered on-premises device in the first set of registered on-premises devices;
verifying the first connected on-premises device is the first registered on-premises device when the device identifier of the first connected on-premises device matches the device identifier of the first registered on-premises device in the first set of registered on-premises devices; and
updating the device identifier of the first registered on-premises device in the first data record when the device identifier of the first connected on-premises device and the device identifier of the first registered on-premises device in the first set of registered on-premises devices do not match.

7. The method of claim 6, wherein updating the first data record based on the first device-reported data further comprises:
comparing a device identifier of the first registered on-premises device in the first set of registered on-premises devices to a device identifier of a second connected on-premises device connected to the first on-premises device in a wireless backhaul included in the first device-reported data;
verifying the second connected on-premises device is a second registered on-premises device in the first set of registered on-premises devices when the device identifier of the second connected on-premises device matches the device identifier of the second registered on-premises device; and
updating the device identifier of the second registered on-premises device in the first data record when the device identifier of the second connected on-premises device and the device identifier of the second registered on-premises device in the first set of registered on-premises devices do not match.

8. The method of claim 7, further comprising:
logging into the second connected on-premises device; and
retrieving second device-reported data from the first connected on-premises device.

9. The method of claim 8, further comprising:
determining, based on the second device-reported data, the second connected on-premises device needs troubleshooting; and
troubleshooting the second connected on-premises device.

10. The method of claim 1, further comprising:
determining whether a service configuration field in the second data record is missing; and
updating the service configuration field based on a service configuration included in the first device-reported data retrieved from the first connected on-premises device.

11. The method of claim 10, further comprising:
determining the first device-reported data does not include the service configuration;
querying a multi-dwelling unit vacancy database for a vacancy status of a service location corresponding to the verified DTN; and
when the vacancy status indicates the service location is occupied, flagging the second data record.

12. The method of claim 11, further comprising:
generating a temporary password and service set identifier (SSID) for the user account;
linking a code to the temporary password and SSID; and
sending the code to a user of the user account.

13. The method of claim 1, further comprising:
comparing the first device list to an inventory database; and
when a device identifier in the first device list matches a device identifier in the inventory database, updating a provisioning status of a corresponding registered on-premises device in the first device list to an un-provisioned status in the first data record.

14. A system comprising:
at least one processing unit; and
memory storing instructions that, when executed by the at least one processing unit, cause the system to perform operations comprising:
retrieving a first data record associated with a user account from a first database, wherein the first data record includes a first device list including a first set of registered on-premises devices registered to the user account in a first platform;
retrieving a second data record associated with the user account from a second database, wherein the second data record includes a second device list including a second set of registered on-premises devices registered to the user account in a second platform;
verifying a distribution transport network (DTN) assigned to the user account in the first data record;
logging into a first connected on-premises device connected to the verified DTN;
retrieving first device-reported data from the first connected on-premises device;
updating the first data record based on the first device-reported data;
and
updating the second data record based on the first data record.

15. The system of claim 14, wherein verifying the DTN assigned to the user account in the first data record comprises:
obtaining a device identifier of a first registered on-premises device in the first set of registered on-premises devices from the first data record;
verifying the device identifier of the first registered on-premises device with a fifth database;
retrieving a MAC address of the first registered on-premises device from a third database based on the device identifier of the first registered on-premises device;
retrieving, from a fourth database, a recorded DTN identifier recorded in association with a network connection made by the first connected on-premises device via a connected DTN; and
verifying the DTN assigned to the user account is the connected DTN connected to the first registered on-premises device when the recorded DTN identifier matches a DTN identifier of the DTN assigned to the user account in the first data record; or
updating the DTN identifier assigned to the user account in the first data record when the recorded DTN identifier and the DTN identifier in the first data record do not match.

16. The system of claim 15, the operations further comprising:
determining a service location corresponding to the verified DTN;
comparing a location identifier corresponding to the verified DTN to a location identifier included in the first data record;
verifying the location identifier included in the first data record when the location identifier included in the first data record matches the location identifier corresponding to the verified DTN; and
updating the location identifier included in the first data record to the identifier corresponding to the verified DTN when the location identifier included in the first data record and the location identifier corresponding to the verified DTN do not match.

17. The system of claim 14, wherein updating the first data record based on the first device-reported data comprises:
comparing a device identifier of the first connected on-premises device in the first device-reported data to a device identifier of a first registered on-premises device in the first set of registered on-premises devices;
verifying the first connected on-premises device is the first registered on-premises device when the device identifier of the first connected on-premises device matches the device identifier of the first registered on-premises device in the first set of registered on-premises devices; and
updating the device identifier of the first registered on-premises device in the first data record to the device identifier of the first connected on-premises device when the device identifier of the first connected on-premises device and the device identifier of the first registered on-premises device in the first set of registered on-premises devices do not match.

18. The system of claim 17, wherein updating the first data record based on the first device-reported data further comprises:
comparing a device identifier of a second registered on-premises device in the first set of registered on-premises devices to a device identifier, included in the first device-reported data, of a second connected on-premises device connected to the first on-premises device in a wireless backhaul;
verifying the second connected on-premises device is a second registered on-premises device in the first set of registered on-premises devices when the device identifier of the second connected on-premises device matches the device identifier of the second registered on-premises device; and
updating the device identifier of the second registered on-premises device in the first data record when the device identifier of the second connected on-premises device and the device identifier of the second registered on-premises device in the first set of registered on-premises devices do not match.

19. The system of claim 18, the operations further comprising:
logging into the second connected on-premises device;
retrieving second device-reported data from the first connected on-premises device;
determining, based on the second device-reported data, whether to troubleshoot the second connected on-premises device; and
troubleshooting the second connected on-premises device when a determination is made to troubleshoot the second connected on-premises device.

20. A method, comprising:
retrieving a first data record associated with a user account from a first database, wherein the first data record includes a first device list including a first set of registered on-premises devices registered to the user account in a first platform;
retrieving a second data record associated with the user account from a second database, wherein the second data record includes a second device list including a second set of registered on-premises devices registered to the user account in a second platform;
obtaining a device identifier of a first registered on-premises device in the first set of registered on-premises devices from the first data record;
retrieving a MAC address of the first registered on-premises device from a third database based on the device identifier of the first registered on-premises device;
retrieving, from a fourth database, a recorded distribution transport network (DTN) identifier recorded in association with a network connection made by the first registered on-premises device via a connected DTN; and
verifying a DTN assigned to the user account is the connected DTN connected to the first registered on-premises device when the recorded DTN identifier matches a DTN identifier of the DTN assigned to the user account in the first data record; or
updating the DTN identifier assigned to the user account in the first data record when the recorded DTN identifier and the DTN identifier in the first data record do not match;
logging into a first connected on-premises device connected to the verified DTN;
retrieving first device-reported data from the first connected on-premises device;
updating the first data record based on the first device-reported data, comprising:
comparing a device identifier of the first connected on-premises device in the first device-reported data to a device identifier of the first registered on-premises device in the first set of registered on-premises devices; and
verifying the first connected on-premises device is the first registered on-premises device when the device identifier of the first connected on-premises device matches the device identifier of the first registered on-premises device in the first set of registered on-premises devices; or
updating the device identifier of the first registered on-premises device in the first data record when the device identifier of the first connected on-premises device and the device identifier of the first registered on-premises device in the first set of registered on-premises devices do not match;
comparing a device identifier of the first registered on-premises device in the first set of registered on-premises devices to a device identifier of a second connected on-premises device connected to the first on-premises device in a wireless backhaul included in the first device-reported data; and
verifying the second connected on-premises device is a second registered on-premises device in the first set of registered on-premises devices when the device identifier of the second connected on-premises device matches the device identifier of the second registered on-premises device; or
updating the device identifier of the second registered on-premises device in the first data record when the device identifier of the second connected on-premises device and the device identifier of the second registered on-premises device in the first set of registered on-premises devices do not match; and
updating the second data record based on the first data record.
